(19) United States
(12) Patent Application Publication
(10) Pub. No.: US 2013/0051496 A1
(43) Pub. Date: Feb. 28, 2013

(54) SINGLE-PHASE DOWN-CONVERTER FOR TRANSLATING IMAGE INTERFERENCE TO GUARD BANDS AND MULTI-MODE WIRELESS COMMUNICATION RECEIVER INCLUDING SINGLE-PHASE DOWN-CONVERSION RECEIVING CIRCUIT AND DUAL-PHASE DOWN-CONVERSION RECEIVING CIRCUIT

(71) Applicants: Chin-Fu LI, Changhua County (TW); Guan-Hong KE, Changhua County (TW); Po-Min WANG, Yunlin County (TW); Po-Chiun HUANG, Hsinchu City (TW)

(72) Inventors: Chin-Fu LI, Changhua County (TW); Guan-Hong KE, Changhua County (TW); Po-Min WANG, Yunlin County (TW); Po-Chiun HUANG, Hsinchu City (TW)

(21) Appl. No.: 13/219,729

(22) Filed: Aug. 29, 2011

(51) Int. Cl. H04L 27/14; H04B 1/26

(52) U.S. Cl. 375/334; 455/313

(57) ABSTRACT

A single-phase down-converter includes a mixer and a local oscillator (LO) signal generator. The mixer is arranged to generate a mixer output signal by mixing a radio frequency (RF) signal and an LO signal. The LO signal generator is coupled to the mixer, and arranged to generate the LO signal with a frequency shifted from an RF carrier frequency by a specific intermediate frequency, wherein when image interference exists, the specific intermediate frequency makes the image interference translated to guard band(s) of channel(s).

### BACKGROUND

The disclosed embodiments of the present invention relate to receiving and demodulating a wireless communication signal, and more particularly, to a single-phase down-converter for translating image interference to guard band(s) of channel(s) and a multi-mode wireless communication receiver including a single-phase down-conversion receiving circuit and a dual-phase down-conversion receiving circuit.

In wireless communication systems, information is modulated and then transmitted over radio frequency (RF) communication channels that are established between two terminals. Each terminal includes RF receiver circuitry used to select a signal of a desired communication channel, and then down-converts the selected RF signal into a received signal with a lower frequency (e.g., an intermediate frequency (IF) signal or a baseband signal) for further signal processing.

In general, a simple modulation scheme, such as frequency-shift keying (FSK) or phase-shift keying (PSK), may be employed for short-range wireless communications. However, due to inherent characteristics of the employed simple modulation scheme, the wireless communication receiver may encounter unwanted image interference, which may degrade the signal reception quality greatly. A complicated modulation scheme, such as IQ modulation, may be employed to avoid the image interference issue. For example, when the IQ modulation is employed at the transmitter side, one of a direct down-conversion, a low-IF down-conversion with complex filters, and a wideband-IF down-conversion with image rejection may be utilized by the receiver side. Specifically, when the IF frequency is selected to be higher than a data rate of the transmitted data, zero-crossing edge trigger is employed to detect the transmitted data. When the IF frequency is set to zero, complex processing is employed to detect the transmitted data. Though the complicated modulation scheme (e.g., IQ modulation) is capable of avoiding the image interference issue, a complicated receiver circuit is needed inevitably, resulting in higher production cost and power consumption. Moreover, the conventional receiver design adopts either a simple down-conversion scheme or a complicated down-conversion scheme. Thus, as the conventional receiver supports a single down-conversion scheme, the use of the conventional receiver lacks flexibility.

### SUMMARY

In accordance with exemplary embodiments of the present invention, a single-phase down-converter for translating image interference to guard band(s) of channel(s) and a multi-mode wireless communication receiver including a single-phase down-conversion receiving circuit and a dual-phase down-conversion receiving circuit are proposed to solve the above-mentioned problem.

According to a first aspect of the present invention, an exemplary single-phase down-converter is disclosed. The exemplary single-phase down-converter includes a mixer and a local oscillator (LO) signal generator. The mixer is arranged to generate a mixer output signal by mixing a radio frequency (RF) signal and an LO signal. The LO signal generator is coupled to the mixer, and arranged to generate the LO signal with a frequency shifted from an RF carrier frequency by a specific intermediate frequency, wherein when image interference exists, the specific intermediate frequency makes the image interference translated to guard band(s) of channel(s).

According to a second aspect of the present invention, an exemplary single-phase down-conversion method is disclosed. The exemplary single-phase down-conversion method includes: generating a local oscillator (LO) signal with a frequency shifted from an RF carrier frequency by a specific intermediate frequency; and generating a mixer output signal by mixing a radio frequency (RF) signal and the LO signal. When image interference exists, the specific intermediate frequency makes the image interference translated to guard band(s) of channel(s).

According to a third aspect of the present invention, an exemplary multi-mode wireless communication receiver is disclosed. The exemplary multi-mode wireless communication receiver includes a single-phase down-conversion receiving circuit, a dual-phase down-conversion receiving circuit, and a controller. The single-phase down-conversion receiving circuit is arranged to perform a single-phase down-conversion upon a radio frequency (RF) signal. The dual-phase down-conversion receiving circuit is arranged to perform a dual-phase down-conversion upon the RF signal. The controller is coupled to the single-phase down-conversion receiving circuit and the dual-phase down-conversion receiving circuit, and arranged to detect existence of image interference and control enabling of the single-phase down-conversion receiving circuit and the dual-phase down-conversion receiving circuit according to an image interference detection result.

According to a third aspect of the present invention, an exemplary multi-mode wireless communication receiver is disclosed. The multi-mode wireless communication receiver includes a down-conversion circuit, a demodulation circuit, and a controller. The down-conversion circuit is arranged to perform a single-phase down-conversion upon a radio frequency (RF) signal and accordingly generate a first analog intermediate frequency (IF) output, and arranged to perform a dual-phase down-conversion upon the RF signal and accordingly generate a second analog IF output. The demodulation circuit includes an analog-to-digital converter (ADC) module, a signal separator, a down-converter, and a demodulator module. The ADC module is arranged to convert the first analog IF output into a first digital IF output, and convert the second analog IF output into a second digital IF output. The signal separator is arranged to separate the first digital IF output into a first digital in-phase baseband signal and a first digital quadrature-phase baseband signal. The down-converter is arranged to convert the second digital IF output into a second digital in-phase baseband signal and a second digital quadrature-phase baseband signal. The demodulator module is arranged to demodulate the first digital in-phase baseband signal and the first digital quadrature-phase baseband signal, and demodulate the second digital in-phase baseband signal and the second digital quadrature-phase baseband signal. The controller is coupled to the demodulation circuit and arranged to detect existence of image interference according to the second digital in-phase baseband signal and the second digital quadrature-phase baseband signal, and control the demodulation circuit according to an image interference detection result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a single-phase down-conversion receiving circuit according to an exemplary embodiment of the present invention.

FIG. 2 is a diagram illustrating an exemplary single-phase down-conversion under a condition where the specific intermediate frequency is higher than zero and lower than a data rate of transmitted data.

FIG. 3 is a diagram illustrating an original data to be transmitted.

FIG. 4 is a diagram illustrating a baseband waveform corresponding to the transmitted data.

FIG. 5 is a phase-domain signal of the transmitted data.

FIG. 6 is a diagram illustrating a demodulated data.

FIG. 7 is a diagram illustrating another exemplary single-phase down-conversion under a condition where the specific intermediate frequency is higher than a data rate of transmitted data.

FIG. 8 is a diagram illustrating a spectrum pattern of a wanted BFSK signal “0” with an unwanted image signal “1”.

FIG. 9 is a diagram illustrating a spectrum pattern of a wanted BFSK signal “0” with an unwanted image signal “0”.

FIG. 10 is a diagram illustrating a spectrum pattern of a wanted BFSK signal “1” with an unwanted image signal “0”.

FIG. 11 is a diagram illustrating a spectrum pattern of a wanted BFSK signal “1” with an unwanted image signal “1”.

FIG. 12 is a diagram illustrating a multi-mode wireless communication receiver according to an exemplary embodiment of the present invention.

FIG. 13 is a diagram illustrating a first exemplary implementation of a multi-mode wireless communication receiver.

FIG. 14 is a diagram illustrating a second exemplary implementation of a multi-mode wireless communication receiver.

FIG. 15 is a diagram illustrating a third exemplary implementation of a multi-mode wireless communication receiver.

FIG. 16 is a diagram illustrating a fourth exemplary implementation of a multi-mode wireless communication receiver.

FIG. 17 is a diagram illustrating a fifth exemplary implementation of a multi-mode wireless communication receiver.

FIG. 18 is a diagram illustrating a multi-mode wireless communication receiver according to another exemplary embodiment of the present invention.

FIG. 19 is a diagram illustrating a first exemplary implementation of a demodulation circuit shown in FIG. 18.

FIG. 20 is a diagram illustrating a second exemplary implementation of a demodulation circuit shown in FIG. 18.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

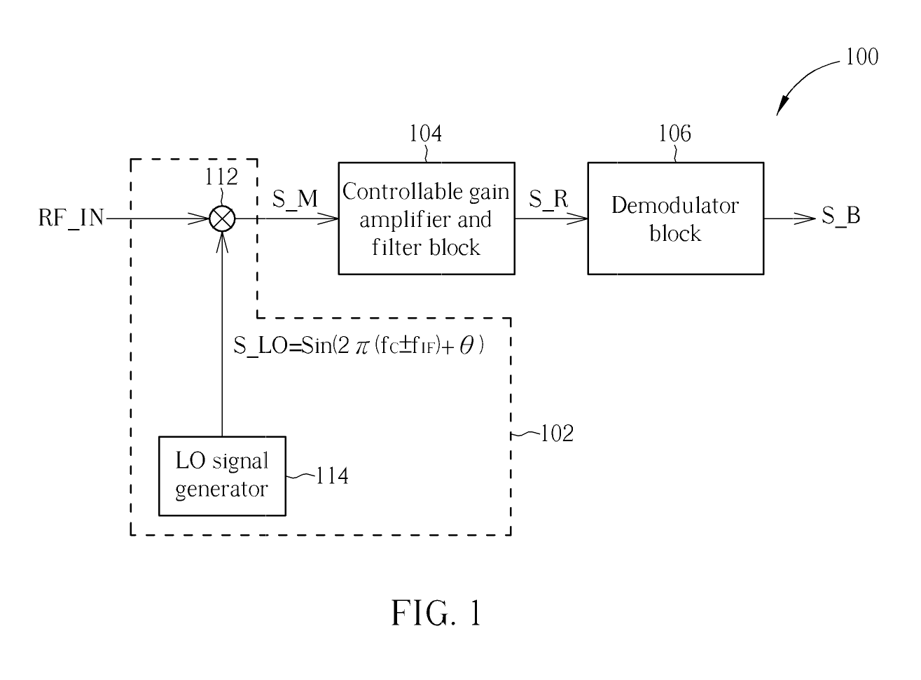

Please refer to FIG. 1, which is a diagram illustrating a single-phase down-conversion receiving circuit according to an exemplary embodiment of the present invention. The exemplary single-phase down-conversion receiving circuit 100 includes a single-phase down-converter 102, a controllable gain amplifier and filter block 104, and a demodulator block 106. In this exemplary embodiment, the single-phase down-converter 102 includes a mixer 112 and an LO signal generator 114. The mixer 112 is arranged to generate a mixer output signal S_M by mixing a radio frequency (RF) signal RF_IN derived from an RF front-end (not shown) and an LO signal S_LO. For example, the RF signal RF_IN is an FSK modulated signal, and the LO signal S_LO is a sinusoidal wave which may be expressed as below:

S_LO=Sin(2π(f_{c}±f_{IF})+θ) (1)

In above formula (1), f_{c} represent an RF carrier frequency, f_{IF} represent an intermediate frequency which is case-dependent, and θ represents a phase shift which is set according to a transmission distance between the transmitter end and the receiver end. More specifically, the LO signal generator 114 is coupled to the mixer 112, and arranged to generate the LO signal S_LO with a frequency shifted from an RF carrier frequency (e.g., f_{c}) by a specific intermediate frequency (e.g., f_{IF}). Please note that the specific intermediate frequency should be properly configured. Therefore, when there is image interference, the specific intermediate frequency is capable of making the undesired image interference translated to guard band(s) of channel(s). Further details are described later.

Due to the inherent mixer characteristics, the mixer output signal S_M includes high-frequency components and low-frequency components. The controllable gain amplifier and filter block 104 may include an amplifier (e.g., a variable gain amplifier (VGA)/programmable gain amplifier (PGA)) and a filter (e.g., a low-pass filter (LPF)). Thus, after processed by the controllable gain amplifier and filter block 104, low-frequency components are extracted from the mixer output signal S_M to act as a received signal S_R. Next, the demodulator block 106 demodulates the incoming received signal S_R and accordingly generates a baseband signal S_B. As the specific intermediate frequency makes the image interference translated to guard band(s) of channel(s), the image interference can be easily filtered by a filter (e.g., an LPF) implemented in the controllable gain amplifier and filter block 104. Though a single-phase down-conversion is employed, the undesired image interference can be alleviated or eliminated. Compared to a dual-phase down-conversion (e.g., an IQ down-conversion), the single-phase down-conversion is simple and consumes less power/current and chip area.

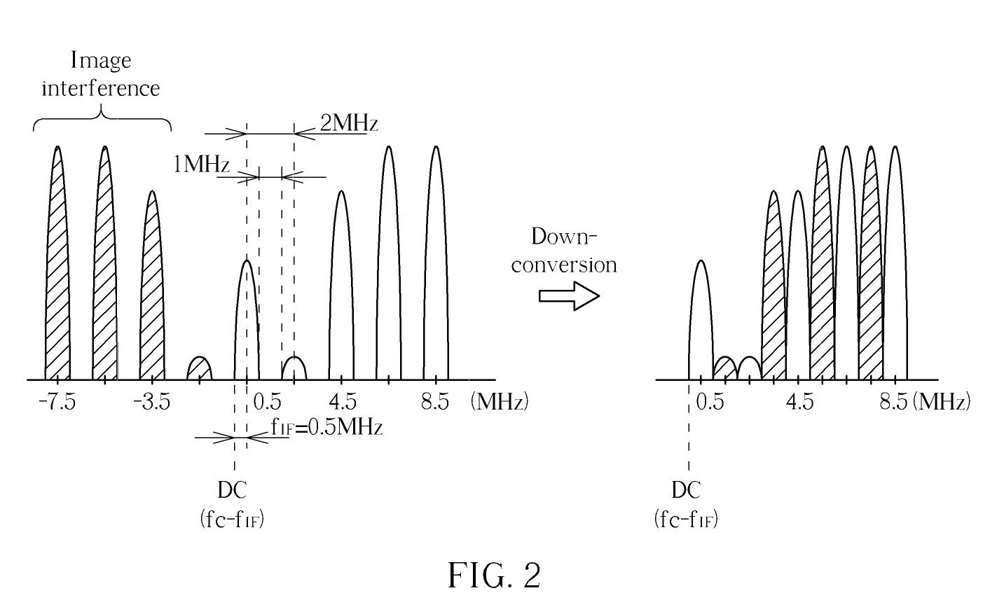

FIG. 2 is a diagram illustrating an exemplary single-phase down-conversion under a condition where the specific intermediate frequency is higher than zero and lower than a data rate of transmitted data. By way of example, but not limitation, the RF signal RF_IN is an FSK modulated signal complying with a Bluetooth-Low Energy (BT-LE) specification. In accordance with the BT-LE specification, the channel bandwidth is 2 Mhz, but the channel bandwidth is not fully utilized. As shown in FIG. 2, there is a 1 Mhz guard band between two adjacent channels. In this exemplary embodiment, a near zero-IF down-conversion is employed. Therefore, the intermediate frequency IF may be set by following formula:

|IF|0.25×BW (2)

In above formula (2), BW represents the channel bandwidth. As shown in FIG. 2, the above-mentioned specific intermediate frequency is set by 0.5 MHz. Due to the 0.5 MHz intermediate frequency which is higher than zero and lower than the data rate of transmitted data, the undesired image interference is translated to guard bands of channels and can be easily filtered out by using a properly designed filter. Thus, there is no image interference issue.

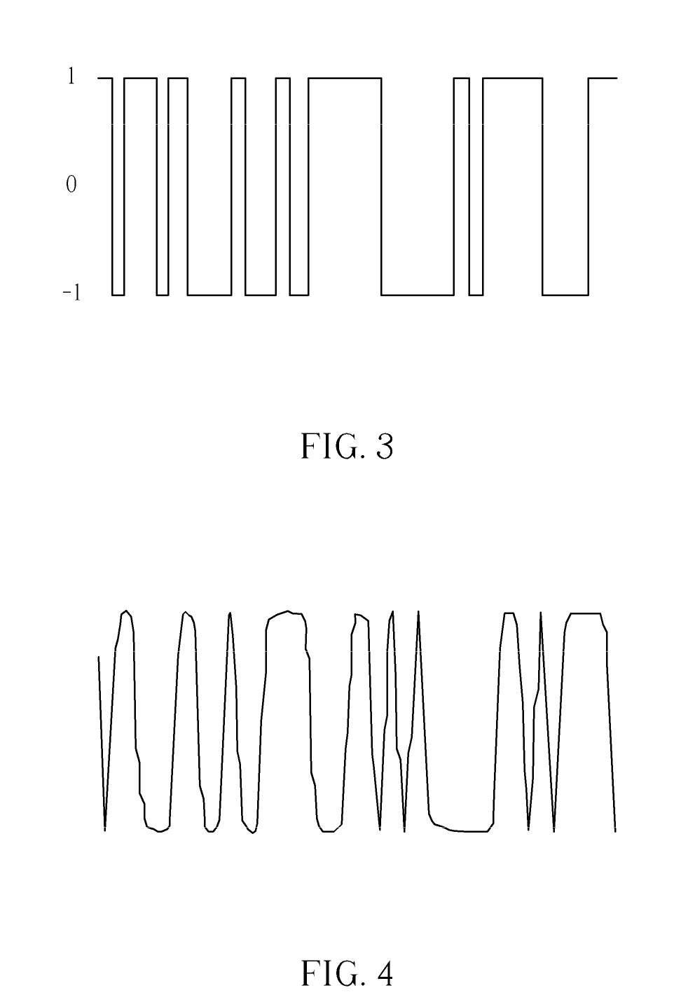

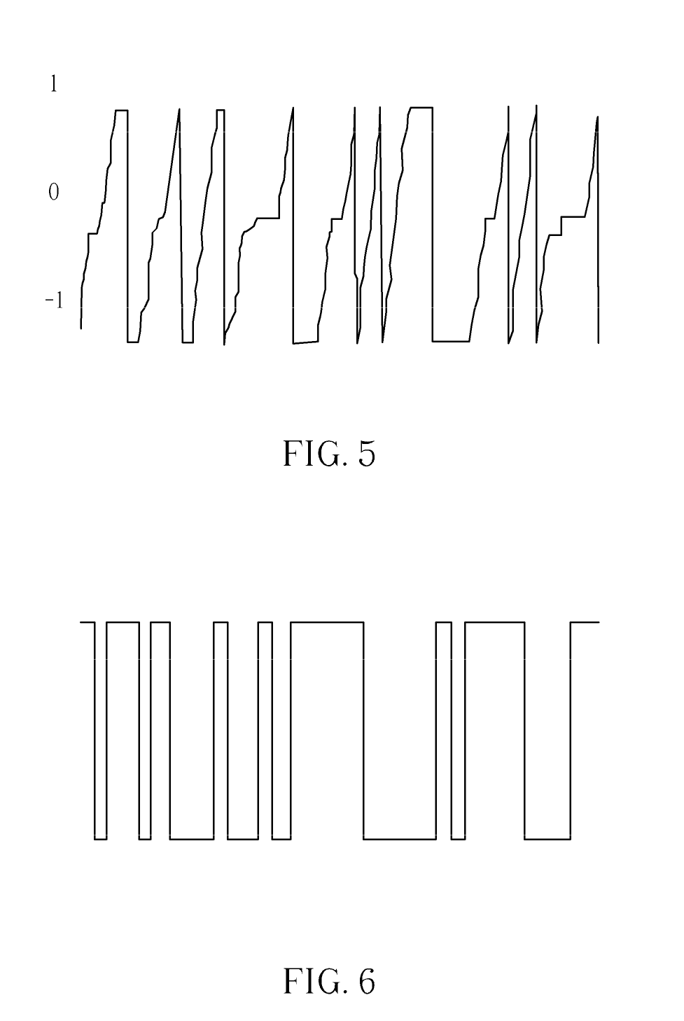

As the intermediate frequency is lower than the data rate of transmitted data, the transmitted data may be demodulated by phase-domain processing. Please refer to FIG. 3, FIG. 4, FIG. 5, and FIG. 6. FIG. 3 is a diagram illustrating an original data to be transmitted. FIG. 4 is a diagram illustrating a baseband waveform corresponding to the transmitted data. FIG. 5 is a phase-domain signal of the transmitted data. FIG. 6 is a diagram illustrating a demodulated data. As can be seen from FIG. 3 and FIG. 6, the demodulated data is substantially identical to the original data. Besides, as can be seen from FIG. 5 and FIG. 6, the data is demodulated by the sign of the phase increase. To put it simply, using phase-domain processing is capable of correctly obtaining the demodulated data when a proposed single-phase down-conversion with an intermediate frequency lower than a data rate of transmitted data is employed in a wireless communication receiver.

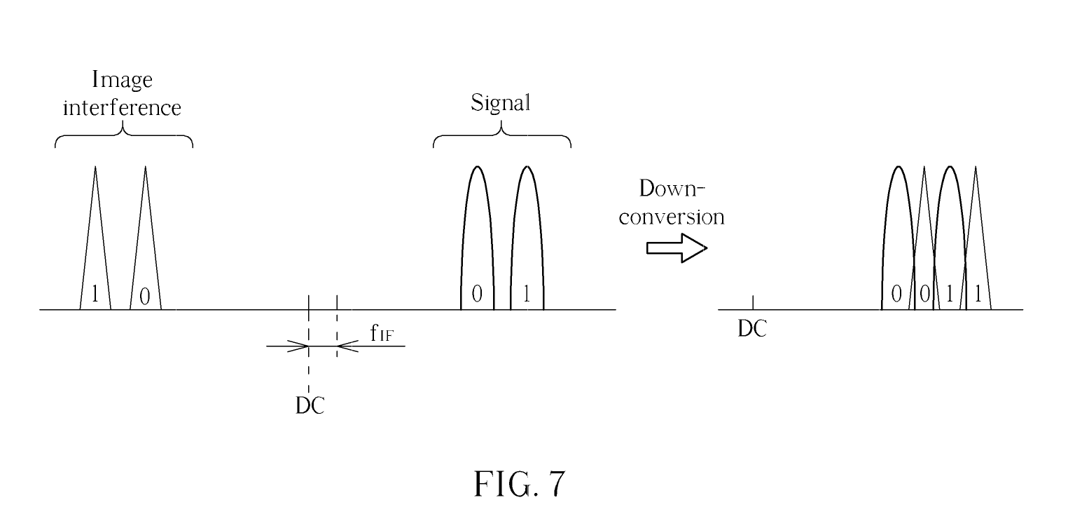

FIG. 7 is a diagram illustrating another exemplary single-phase down-conversion under a condition where the specific intermediate frequency is higher than a data rate of transmitted data. By way of example, but not limitation, the RF signal RF_IN is an FSK modulated signal such as a binary frequency-shift keying (BFSK) modulated signal. Similarly, the channel bandwidth is not fully utilized. As shown in FIG. 2, there are guard bands adjacent to channels. In this exemplary embodiment, the intermediate frequency IF may be set by following formula:

|IF|(n+0.5+ε)×BW (3)

In above formula (3), n represents the number of channels, ε represents a shifted frequency, and BW represents the channel bandwidth. As shown in FIG. 7, the undesired image interference would be translated to the guard bands due to the shifted frequency ε.

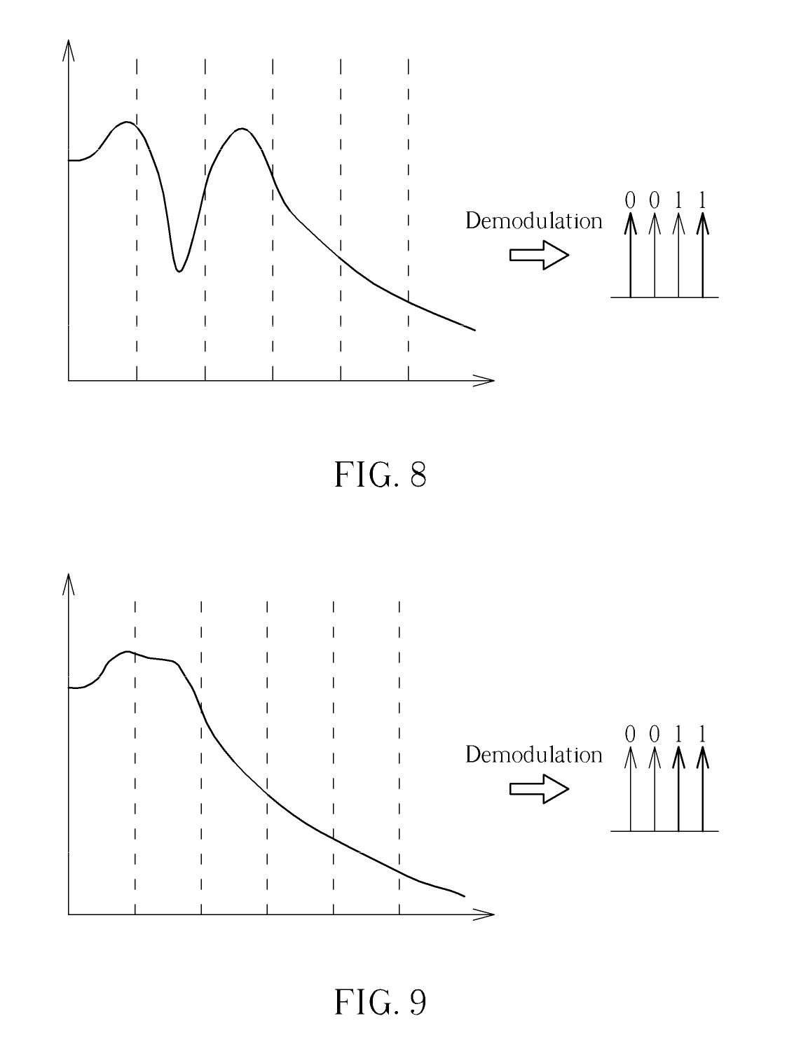

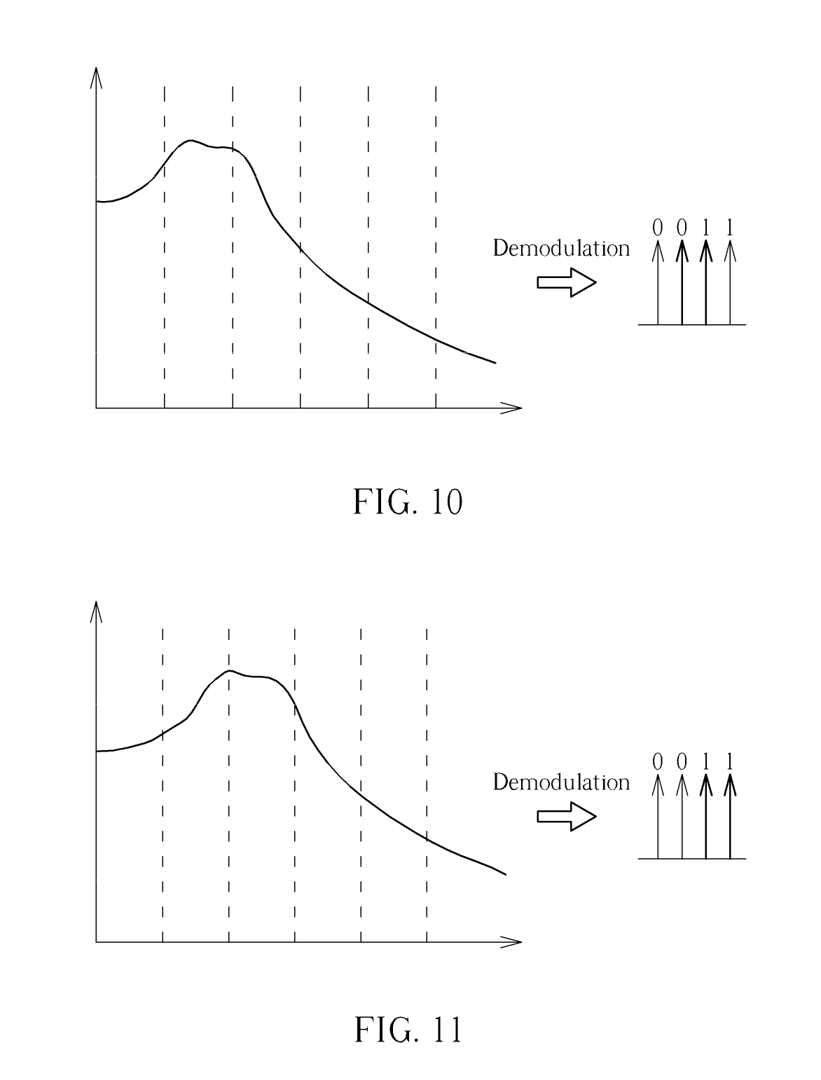

As the intermediate frequency is higher than the data rate of transmitted data, the transmitted data may be demodulated by fast Fourier transform (FFT). That is, the demodulation scheme is similar to that of a simplified orthogonal frequency-division multiplexing (OFDM) system. More specifically, data can be demodulated by monitoring spectrum patterns. Please refer to FIG. 8, FIG. 9, FIG. 10, and FIG. 11. FIG. 8 is a diagram illustrating a spectrum pattern of a wanted BFSK signal “0” with an unwanted image signal “1”. FIG. 9 is a diagram illustrating a spectrum pattern of a wanted BFSK signal “0” with an unwanted image signal “0”. FIG. 10 is a diagram illustrating a spectrum pattern of a wanted BFSK signal “1” with an unwanted image signal “0”. FIG. 11 is a diagram illustrating a spectrum pattern of a wanted BFSK signal “1” with an unwanted image signal “1”. Thus, by monitoring the spectrum pattern, the data of BFSK signal and image signal can be easily obtained. To put it simply, using spectrum pattern monitoring is capable of correctly obtaining the demodulated data when a proposed single-phase down-conversion with an intermediate frequency higher than a data rate of transmitted data is employed in a wireless communication receiver.

Briefly summarized, the proposed single-phase down-conversion scheme is capable of obtaining the demodulated data without the need of conventional IQ complex processing, thereby greatly saving the power and chip area. In above exemplary embodiments, the proposed single-phase down-conversion scheme is employed in an FSK receiver; however, this is for illustrative purposes only, and is not meant to be a limitation of the present invention. Any wireless communication receiver using the proposed single-phase down-conversion scheme obeys the spirit of the present invention and falls within the scope of the present invention.

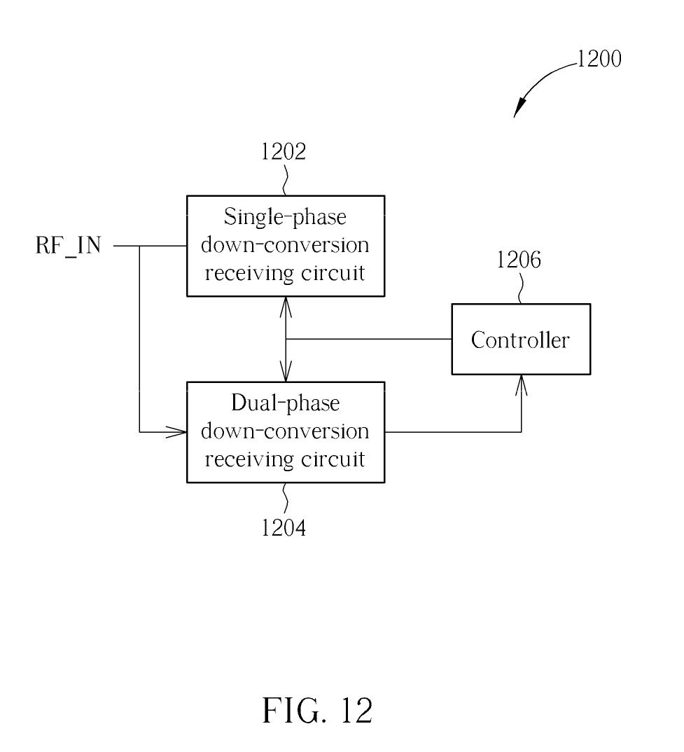

In general, the conventional receiver design adopts either a simple down-conversion scheme (e.g., single-phase down-conversion which requires a single mixer) or a complicated down-conversion scheme (e.g., dual-phase down-conversion which requires two mixers), thus lacking flexibility. To solve this problem, the present invention further proposes a multi-mode wireless communication receiver. Please refer to FIG. 12, which is a diagram illustrating a multi-mode wireless communication receiver according to an exemplary embodiment of the present invention. In this exemplary embodiment, the multi-mode wireless communication receiver 1200 is a dual-mode wireless communication receiver including a single-phase down-conversion receiving circuit 1202, a dual-phase down-conversion receiving circuit 1204, and a controller 1206. The single-phase down-conversion receiving circuit 1202 is arranged to perform a single-phase down-conversion upon a radio frequency (RF) signal RF_IN. The dual-phase down-conversion receiving circuit 1204 is arranged to perform a dual-phase down-conversion upon the RF signal RF_IN. The controller 1206 is coupled to the single-phase down-conversion receiving circuit 1202 and the dual-phase down-conversion receiving circuit 1204, and arranged to detect existence of image interference and control enabling of the single-phase down-conversion receiving circuit 1202 and the dual-phase down-conversion receiving circuit 1204 according to an image interference detection result. In this exemplary embodiment, the controller 1206 is arranged to detect existence of the image interference by referring to information provided from the dual-phase down-conversion receiving circuit 1204. For example, an in-phase signal and a quadrature-phase signal processed in the dual-phase down-conversion receiving circuit 1204 may be used by the controller 1206 for image interference detection.

The controller 1206 makes the single-phase down-conversion receiving circuit 1202 enabled and the dual-phase down-conversion receiving circuit 1204 disabled when the image interference detection result indicates that there is no image interference. Thus, as the single-phase down-conversion receiving circuit 1202 employs a simple down-conversion/demodulation scheme for deriving transmitted data from the RF signal RF_IN, the power consumption of the multi-mode wireless communication receiver 1200 is reduced greatly. However, when the image interference detection result indicates that there is image interference, the controller 1206 makes the dual-phase down-conversion receiving circuit 1204 enabled and the single-phase down-conversion receiving circuit 1202 disabled. Compared to the single-phase down-conversion receiving circuit 1202, the dual-phase down-conversion receiving circuit 1204 has better image rejection capability. Thus, the performance of deriving transmitted data from the RF signal RF_IN is not degraded due to existence of the undesired image interference.

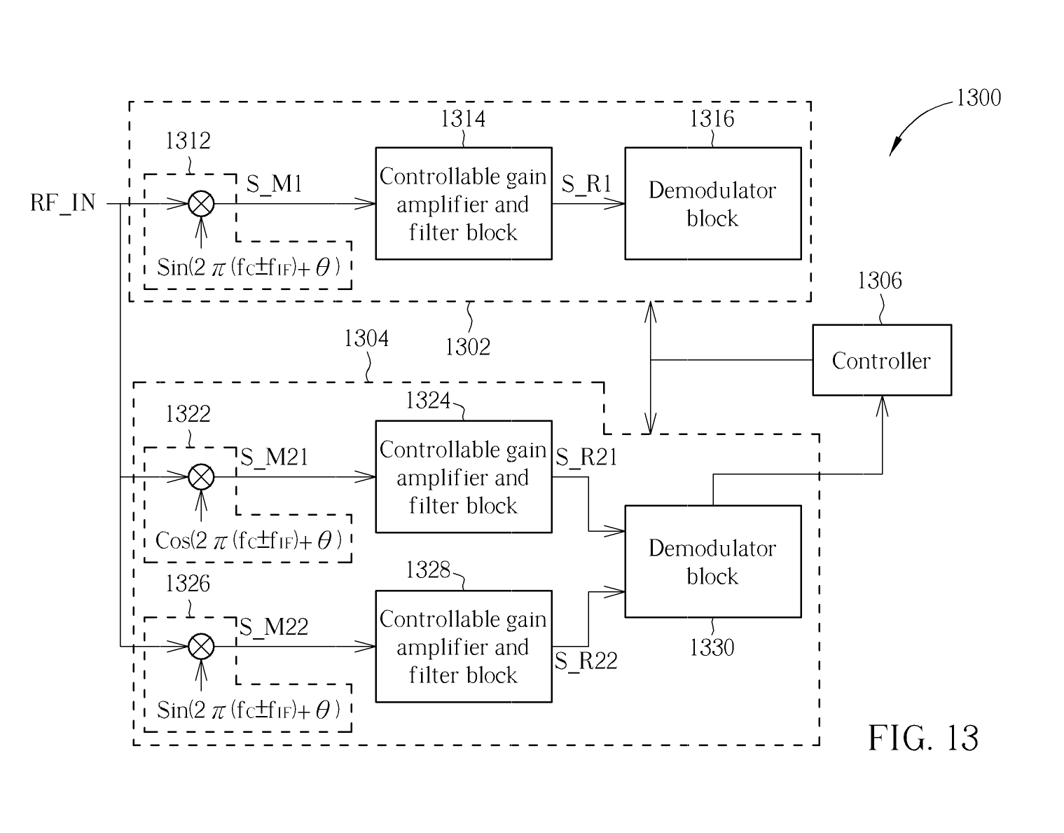

Please refer to FIG. 13, which is a diagram illustrating a first exemplary implementation of a multi-mode wireless communication receiver. The multi-mode wireless communication receiver 1300 is based on the receiver configuration shown in FIG. 12, and therefore includes a single-phase down-conversion receiving circuit 1302, a dual-phase down-conversion receiving circuit 1304, and a controller 1306. The single-phase down-conversion receiving circuit 1302 includes a down-converter 1312, a controllable gain amplifier and filter block 1314, and a demodulator block 1316. The down-converter 1312 is arranged to generate a mixer output signal S_M1 by mixing an RF signal RF_IN and an LO signal (e.g., Sin(2π(f_{c}±f_{IF})+θ)). The controllable gain amplifier and filter block 1314 is coupled to the down-converter 1312, and may include a VGA/PGA and a filter for generating a received signal S_R1 by processing the mixer output signal S_M1. The demodulator block 1316 is arranged to demodulate the received signal S_R1 for generating a baseband signal which carries the desired data.

Regarding the dual-phase down-conversion receiving circuit 1304, it includes a plurality of down-converters 1322 and 1326, a plurality of controllable gain amplifier and filter blocks 1324 and 1328, and a demodulator block 1330. In this exemplary embodiment, the dual-phase down-conversion receiving circuit 1304 employs an IQ demodulation scheme. Therefore, the down-converter 1326 is arranged to generate a mixer output signal S_M22 by mixing the RF signal RF_IN and an LO signal (e.g., Sin(2π(f_{c}±f_{IF})+θ)), and the down-converter 1322 is arranged to generate a mixer output signal S_M21 by mixing the RF signal RF_IN and another LO signal (e.g., Cos(2π(f_{c}±f_{IF})+θ)). Each of the controllable gain amplifier and filter blocks 1324 and 1328 may include a VGA/PGA and a filter. More specifically, the controllable gain amplifier and filter block 1324 is coupled to the down-converter 1322 and arranged to generate a received signal S_R21 by processing the mixer output signal S_M21, and the controllable gain amplifier and filter block 1328 is coupled to the down-converter 1326 and arranged to generate a received signal S_R22 by processing the mixer output signal S_M22.

The demodulator block 1330 is coupled to both of the controllable gain amplifier and filter blocks 1324 and 1328, and arranged to demodulate the received signals S_R21 and S_R22 obtained from the in-phase branch and the quadrature-phase branch to generate a baseband signal which carries the desired data. The controller 1306 obtains information (e.g., in-phase baseband signal and quadrature-phase baseband signal) from the demodulator block 1330 of the dual-phase down-conversion receiving circuit 1304, and performs image interference detection according to the obtained information. Based on the image interference detection result, the controller 1306 determines which one of the single-phase down-conversion receiving circuit 1302 and the dual-phase down-conversion receiving circuit 1304 is allowed to be active for dealing with the incoming RF signal RF_IN.

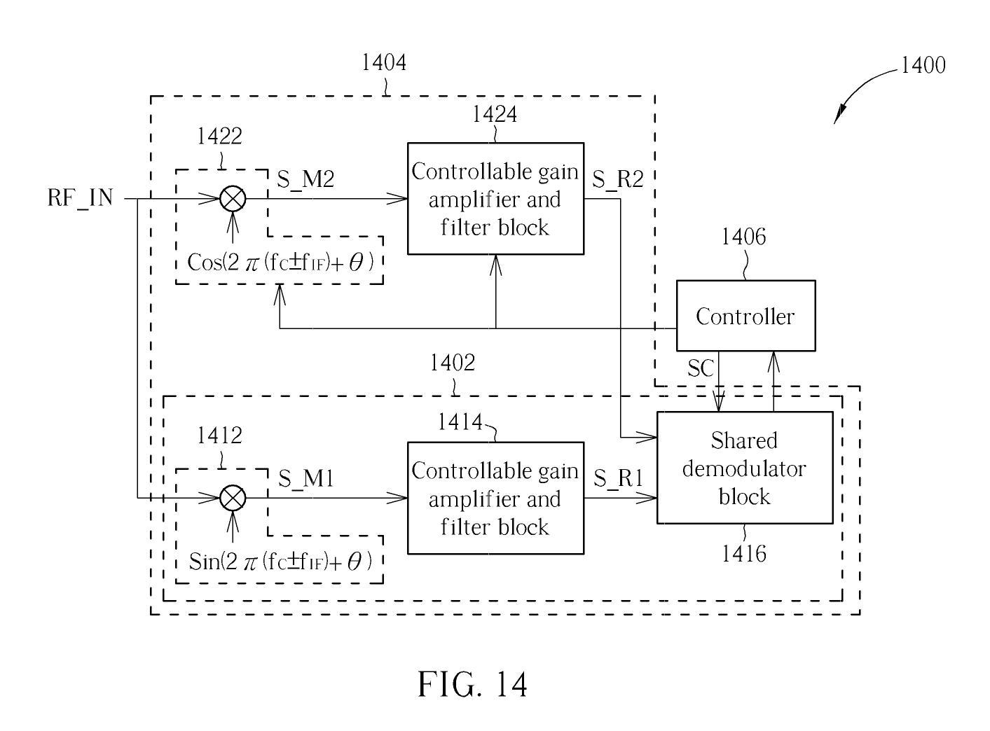

As shown in FIG. 13, the single-phase down-conversion receiving circuit 1302 and the dual-phase down-conversion receiving circuit 1304 are deployed in the receiver, individually. However, this is for illustrative purposes only. A hardware sharing technique may be employed to reduce the production cost and power consumption. Please refer to FIG. 14, which is a diagram illustrating a second exemplary implementation of a multi-mode wireless communication receiver. The multi-mode wireless communication receiver 1400 is also based on the receiver configuration shown in FIG. 12, and therefore includes a single-phase down-conversion receiving circuit 1402, a dual-phase down-conversion receiving circuit 1404, and a controller 1406. As shown in FIG. 14, the single-phase down-conversion receiving circuit 1402 includes a down-converter 1412, a controllable gain amplifier and filter block 1414, and a shared demodulator block 1416. The down-converter 1412 is arranged to generate a mixer output signal S_M1 by mixing the RF signal RF_IN and an LO signal Sin(2π(f_{c}±f_{IF})+θ). The controllable gain amplifier and filter block 1414 may include a VGA/PGA and a filter, and is arranged to generate a received signal S_R1 to the shared demodulator block 1416 by processing the mixer output signal S_M1. As the multi-mode wireless communication receiver 1400 employs the hardware sharing technique, the single-phase down-conversion receiving circuit 1402 is part of the dual-phase down-conversion receiving circuit 1404. That is, the dual-phase down-conversion receiving circuit 1404 has the aforementioned down-converter 1412, controllable gain amplifier and filter block 1414, and shared demodulator block 1416 included therein, and further includes a down-converter 1422 and a controllable gain amplifier and filter block 1424. The down-converter 1422 is arranged to generate a mixer output signal S_M2 by mixing the RF signal RF_IN and another LO signal Cos(2π(f_{c}±f_{IF})+θ). The controllable gain amplifier and filter block 1424 may include a VGA/PGA and a filter, and is arranged to generate a received signal S_R2 to the shared demodulator block 1416 by processing the mixer output signal S_M2.

The controller 1406 obtains information (e.g., in-phase baseband signal and quadrature-phase baseband signal) from the shared demodulator block 1416, and performs image interference detection according to the obtained information. Based on the image interference detection result, the controller 1406 determines which one of the single-phase down-conversion receiving circuit 1402 and the dual-phase down-conversion receiving circuit 1404 is allowed to be active for dealing with the incoming RF signal RF_IN. For example, when the image interference detection indicates that there is no image interference, the controller 1406 would disable the down-converter 1422 and the controllable gain amplifier and filter block 1424, thereby allowing the single-phase down-conversion receiving circuit 1402 to be active. Please note that the shared demodulator block 1416 is arranged to demodulate the received signal S_R1 when the controller 1406 makes the single-phase down-conversion receiving circuit 1402 enabled, and is arranged to demodulate the received signals S_R1 and S_R2 when the controller 1406 makes the dual-phase down-conversion receiving circuit 1404 enabled. Due to the inherent discrepancy between the single-phase down-conversion and the dual-phase down-conversion, the shared demodulator block 1416 may be configured to have hardware elements dedicated to processing a single-phase down-conversion output, hardware elements dedicated to processing a dual-phase down-conversion output, and common hardware elements shared for processing of the single-phase down-conversion output and the dual-phase down-conversion output. Thus, the controller 1406 also generates a control signal SC to the shared demodulator block 1416 for instructing the shared demodulator block 1416 to have a first hardware configuration for processing the single-phase down-conversion output or a second hardware configuration for processing the dual-phase down-conversion output.

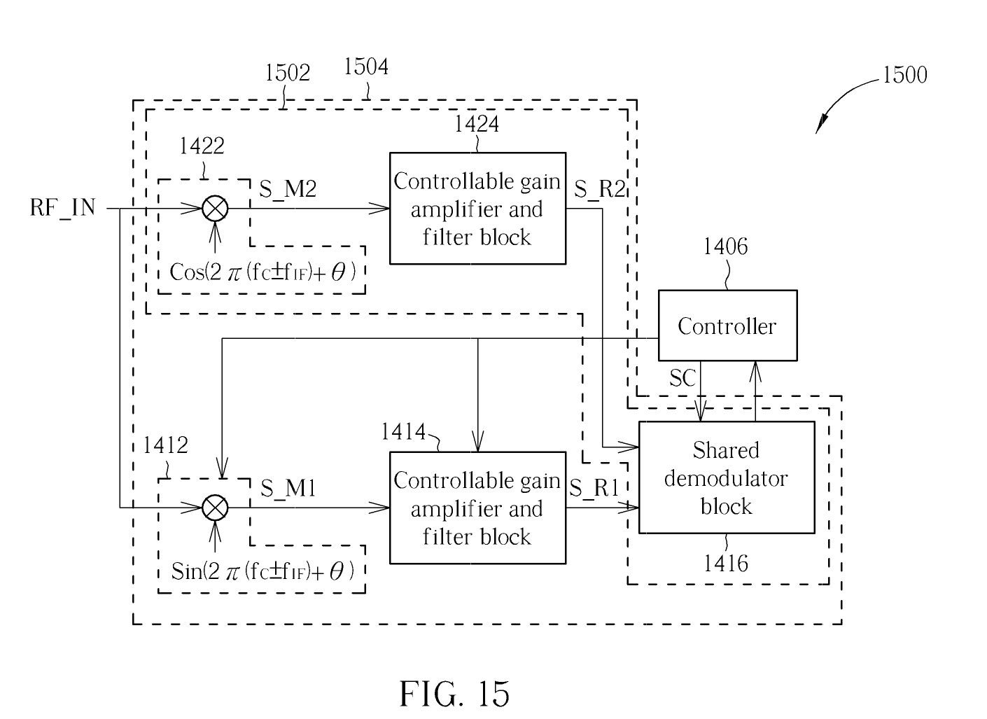

Please refer to FIG. 15, which is a diagram illustrating a third exemplary implementation of a multi-mode wireless communication receiver. The multi-mode wireless communication receiver 1500 is also based on the receiver configuration shown in FIG. 12, and therefore includes a single-phase down-conversion receiving circuit 1502, a dual-phase down-conversion receiving circuit 1504, and the controller 1406. The multi-mode wireless communication receiver 1500 employs the hardware sharing technique. Regarding the exemplary embodiment shown in FIG. 14, the single-phase down-conversion receiving circuit 1402 includes the down-converter 1412 operating according to the LO signal Sin(2π(f_{c}±f_{IF})+θ), and the down-converter 1422 operating according to another LO signal Cos(2π(f_{c}±f_{IF})+θ) and the controllable gain amplifier and filter block 1424 are both disabled when the single-phase down-conversion receiving circuit 1402 is selected and enabled by the controller 1406. However, in the exemplary embodiment shown in FIG. 15, the single-phase down-conversion receiving circuit 1502 includes the down-converter 1422 operating according to the LO signal Cos(2π(f_{c}±f_{IF})+θ), the controllable gain amplifier and filter block 1424, and the shared demodulator block 1416. Therefore, the down-converter 1412 operating according to another LO signal Sin(2π(f_{c}±f_{IF})+θ) and the controllable gain amplifier and filter block 1414 are both disabled when the single-phase down-conversion receiving circuit 1502 is selected and enabled by the controller 1406. This alternative design also obeys the spirit of the present invention.

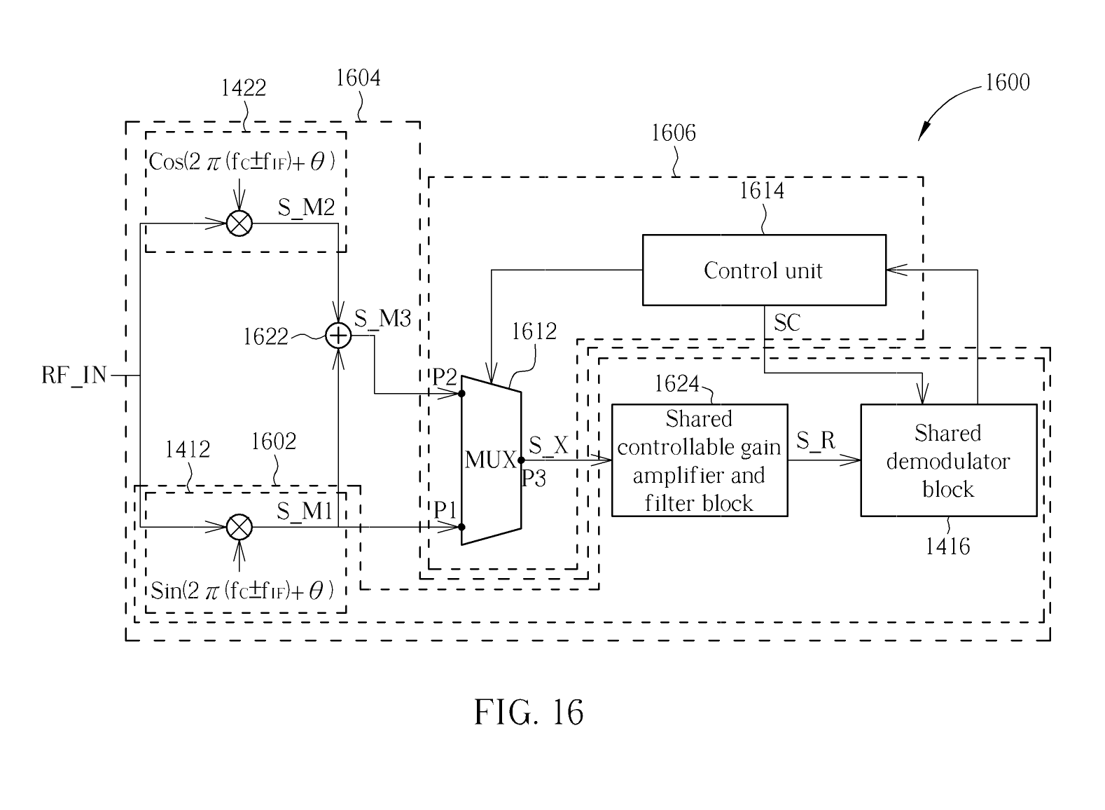

Please refer to FIG. 16, which is a diagram illustrating a fourth exemplary implementation of a multi-mode wireless communication receiver. The multi-mode wireless communication receiver 1600 is also based on the receiver configuration shown in FIG. 12, and therefore includes a single-phase down-conversion receiving circuit 1602, a dual-phase down-conversion receiving circuit 1604, and the controller 1606. The multi-mode wireless communication receiver 1600 employs the hardware sharing technique. As shown in FIG. 16, the controller 1606 includes a multiplexer (MUX) 1612 having a first input port P1, a second input port P2, and an output port P3, and further includes a control unit 1614 arranged to detect existence of the image interference and control the output port P3 to be selectively coupled to the first input port P1 or the second input port P2 according to the image interference detection result. Similarly, the controller 1614 generates a control signal SC to the shared demodulator block 1416 for instructing the shared demodulator block 1416 to have a first hardware configuration for processing the single-phase down-conversion output or a second hardware configuration for processing the dual-phase down-conversion output.

The single-phase down-conversion receiving circuit 1602 includes a shared controllable gain amplifier and filter block 1624 and the aforementioned down-converter 1412 and shared demodulator block 1416. The down-converter 1412 generates a mixer output signal S_M1 to the first input port P1 of the multiplexer 1612. The shared controllable gain amplifier and filter block 1624 may include a VGA/PGA and a filter, and is coupled to the output port P3 of the multiplexer 1612 and arranged to generate a received signal S_R according to a multiplexer output signal S_X generated from the output port P3.

Due to the hardware sharing technique employed by the multi-mode wireless communication receiver 1600, the single-phase down-conversion receiving circuit 1602 is part of the dual-phase down-conversion receiving circuit 1604. As shown in FIG. 16, the dual-phase down-conversion receiving circuit 1604 further includes an image-rejection mixer 1622 and the aforementioned down-converter 1422. The image-rejection mixer 1622 is coupled to the down-converters 1412 and 1422, and arranged to generate a mixer output signal S_M3 to the second input port P2 of the multiplexer 1612 according to the mixer output signals S_M1 and S_M2. In this exemplary embodiment, when the control unit 1614 judges that there is no image interference, the controller 1606 makes the single-phase down-conversion receiving circuit 1602 enabled and the dual-phase down-conversion receiving circuit 1604 disabled by controlling the multiplexer 1612 to couple the output port P3 to the first input port P1 for allowing the mixer output signal S_M1 to act as the multiplexer output signal S_X fed into the following shared controllable gain amplifier and filter block 1624. However, when the control unit 1614 judges that there is image interference, the controller 1606 makes the single-phase down-conversion receiving circuit 1602 disabled and the dual-phase down-conversion receiving circuit 1604 enabled by controlling the multiplexer 1612 to couple the output port P3 to the second input port P2 for allowing the mixer output signal S_M3 to act as the multiplexer output signal S_X fed into the following shared controllable gain amplifier and filter block 1624. In other words, the image interference is removed by the image-rejection mixer 1622 before a combination of signals of the I-branch and Q-branch is fed into the shared controllable gain amplifier and filter block 1624.

In the exemplary embodiment shown in FIG. 16, the down-converter 1412 operating according to the LO signal Sin(2π(f_{c}±f_{IF})+θ) is included in the single-phase down-conversion receiving circuit 1602, and the down-converter 1422 operating according to the LO signal Cos(2π(f_{c}±f_{IF})+θ) is a dedicated element of the dual-phase down-conversion receiving circuit 1604. However, in an alternative design, the down-converter 1412 operating according to the LO signal Sin(2π(f_{c}±f_{IF})+θ) may be a dedicated element of the dual-phase down-conversion receiving circuit 1604, and the down-converter 1422 operating according to the LO signal Cos(2π(f_{c}±f_{IF})+θ) may be included in the single-phase down-conversion receiving circuit 1602. As a person skilled in the art can readily understand details of such alternative design after reading above paragraphs directed to the exemplary embodiment shown in FIG. 15, further description is omitted here for brevity.

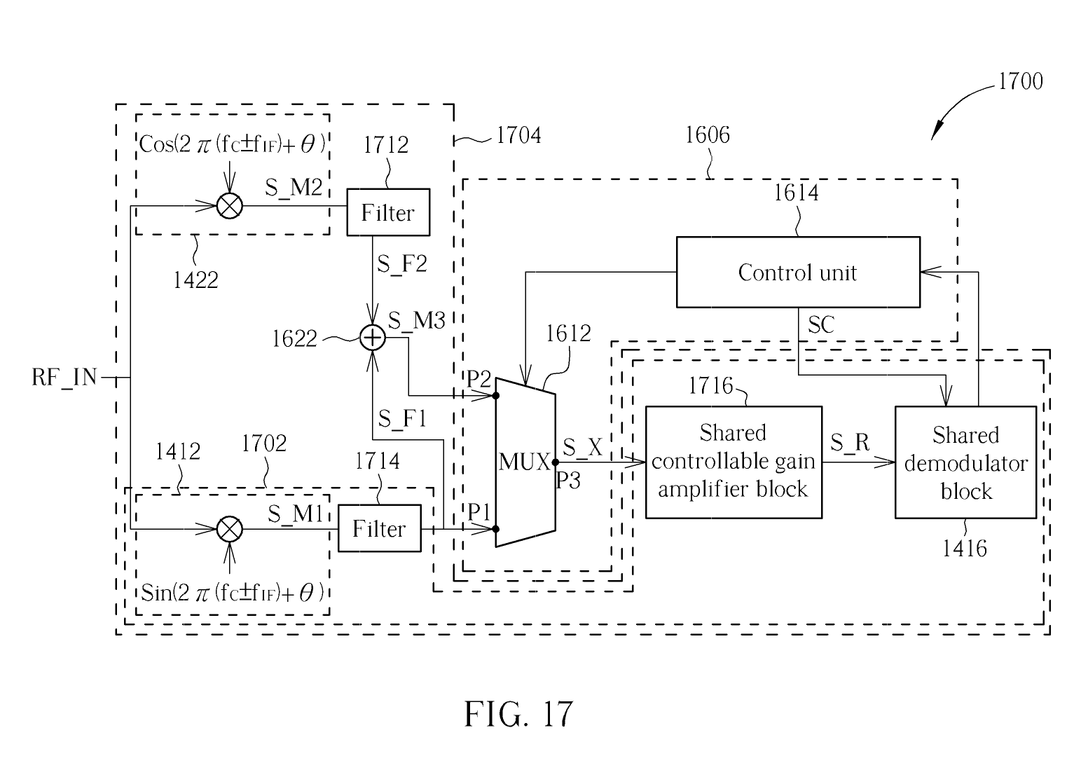

Please refer to FIG. 17, which is a diagram illustrating a fifth exemplary implementation of a multi-mode wireless communication receiver. The multi-mode wireless communication receiver 1700 is also based on the receiver configuration shown in FIG. 12, and therefore includes a single-phase down-conversion receiving circuit 1702, a dual-phase down-conversion receiving circuit 1704, and the aforementioned controller 1606. The multi-mode wireless communication receiver 1700 employs the hardware sharing technique. The major difference between the multi-mode wireless communication receivers 1600 and 1700 is that the shared controllable gain amplifier and filter block 1624 is split into a shared controllable gain amplifier block (e.g., a VGA or a PGA) 1716 and a plurality of filters (e.g., low-pass filters) 1712 and 1714. As shown in FIG. 17, the shared controllable gain amplifier block 1716 is coupled between the output port P3 of the multiplexer 1612 and the shared demodulator block 1416, and arranged to generate the received signal S_R according to the multiplexer output signal S_X. Besides, one filter 1712 is disposed between the down-converter 1422 and the image-rejection mixer 1622, and another filter 1714 is disposed between the down-converter 142 and the multiplexer 1612, wherein the filter 1714 is included in the single-phase down-conversion receiving circuit 1702, and the filter 1712 is a dedicated element of the dual-phase down-conversion receiving circuit 1704. More specifically, the filter 1714 is arranged to generate a filter output signal S_F1 to the first input port P1 of the multiplexer 1612 according to the mixer output signal S_M1, the filter 1712 is arranged to generate a filter output signal S_F2 according to the mixer output signal S_M2, and the image-rejection mixer 1622 is now arranged to generate the mixer output signal S_M3 to the second input port P2 of the multiplexer 1612 according to filter outputs of the mixer output signals S_M1 and S_M2.

In the exemplary embodiment shown in FIG. 17, the down-converter 1412 operating according to the LO signal Sin(2π(f_{c}±f_{IF})+θ) is included in the single-phase down-conversion receiving circuit 1702, and the down-converter 1422 operating according to the LO signal Cos(2π(f_{c}±f_{IF})+θ) is a dedicated element of the dual-phase down-conversion receiving circuit 1704. However, in an alternative design, the down-converter 1412 operating according to the LO signal Sin(2π(f_{c}±f_{IF})+θ) may be a dedicated element of the dual-phase down-conversion receiving circuit 1704, and the down-converter 1422 operating according to the LO signal Cos(2π(f_{c}±f_{IF})+θ) may be included in the single-phase down-conversion receiving circuit 1702. This also obeys the spirit of the present invention.

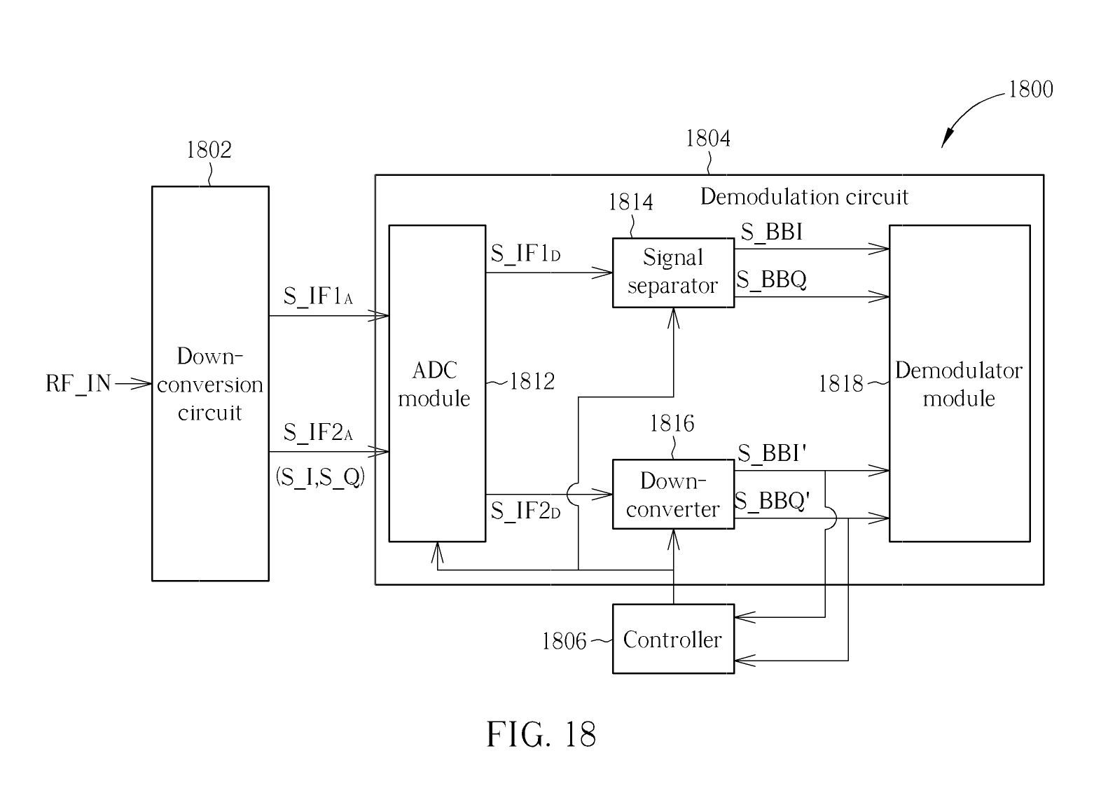

Please refer to FIG. 18, which is a diagram illustrating a multi-mode wireless communication receiver according to another exemplary embodiment of the present invention. The multi-mode wireless communication receiver 1800 includes a down-conversion circuit 1802, a demodulation circuit 1804, and a controller 1806. The down-conversion circuit 1802 is arranged to perform a single-phase down-conversion upon an RF signal RF_IN and accordingly generate an analog intermediate frequency (IF) output S_IF1_{A}, and further arranged to perform a dual-phase down-conversion upon the RF signal RF_IN and accordingly generate an analog IF output S_IF2_{A}. For example, the analog IF output S_IF2_{A} may include an analog in-phase IF signal SI and an analog quadrature-phase IF signal S_Q. Please note that the down-conversion circuit 1802 may be implemented by one of the down-conversion designs illustrated in aforementioned exemplary receiver configurations. By way of example, but not limitation, the down-conversion circuit 1802 may be realized by the down-converters 1312, 1322, 1326 and the controllable gain amplifier and filter blocks 1314, 1324, 1328 shown in FIG. 13, wherein the received signal S_R1 serves as the analog IF output S_IF1_{A}, and the received signals S_R21 and S_R22 serve as the analog in-phase IF signal SI and analog quadrature-phase IF signal S_Q of the analog IF output S_IF2_{A}.

The demodulation circuit 1804 includes an analog-to-digital converter (ADC) module 1812, a signal separator 1814, a down-converter 1816, and a demodulator module 1818. The ADC module 1812 is arranged to convert the analog IF output S_IF1_{A} into a digital IF output S_IF1_{D}, and further arranged to convert the analog IF output S_IF2_{A} into a digital IF output S_IF2_{D}. The signal separator 1814 is arranged to perform IQ separation, and therefore separates the incoming digital IF output S_IF1_{D} into a digital in-phase baseband signal S_BBI and a digital quadrature-phase baseband signal S_BBQ. By way of example, but not limitation, the signal separator 1814 may be implemented using a signal separator proposed in U.S. patent publication No. 2009/0310717 A1, entitled “SIGNAL CONVERTERS” and incorporated herein by reference.

The down-converter 1816 is arranged to convert the digital IF output S_IF2_{D} into a digital in-phase baseband signal S_BBI′ and a digital quadrature-phase baseband signal S_BBQ′. The demodulator module 1818 is arranged to demodulate the digital in-phase baseband signal S_BBI and the digital quadrature-phase baseband signal S_BBQ when receiving the digital in-phase baseband signal S_BBI and the digital quadrature-phase baseband signal S_BBQ, and further arranged to demodulate the digital in-phase baseband signal S_BBI′ and the digital quadrature-phase baseband signal S_BBQ′ when receiving the digital in-phase baseband signal S_BBI′ and the digital quadrature-phase baseband signal S_BBQ′.

In this exemplary embodiment, the controller 1806 is coupled to the demodulation circuit 1804, and is arranged to detect existence of image interference according to the digital in-phase baseband signal S_BBI′ and the digital quadrature-phase baseband signal S_BBQ′, and control the demodulation circuit 1804 according to an image interference detection result. For example, when the controller 1806 detects that there is no image interference, the controller 1806 makes the signal separator 1814 enabled and the down-converter 1816 disabled; besides, the controller 1806 may further make the ADC function applied to the analog IF output S_IF1_{A} enabled and the ADC function applied to the analog IF output S_IF2_{A} disabled. When the controller 1806 detects that there is image interference, the controller 1806 makes the signal separator 1814 disabled and the down-converter 1816 enabled; besides, the controller 1806 may further make the ADC function applied to the analog IF output S_IF1_{A} disabled and the ADC function applied to the analog IF output S_IF2_{A} enabled. That is, the controller 1806 is capable of controlling the demodulation circuit 1804 to switch between a single-phase digital signal processing mode and a dual-phase digital signal processing mode according to an image interference detection result.

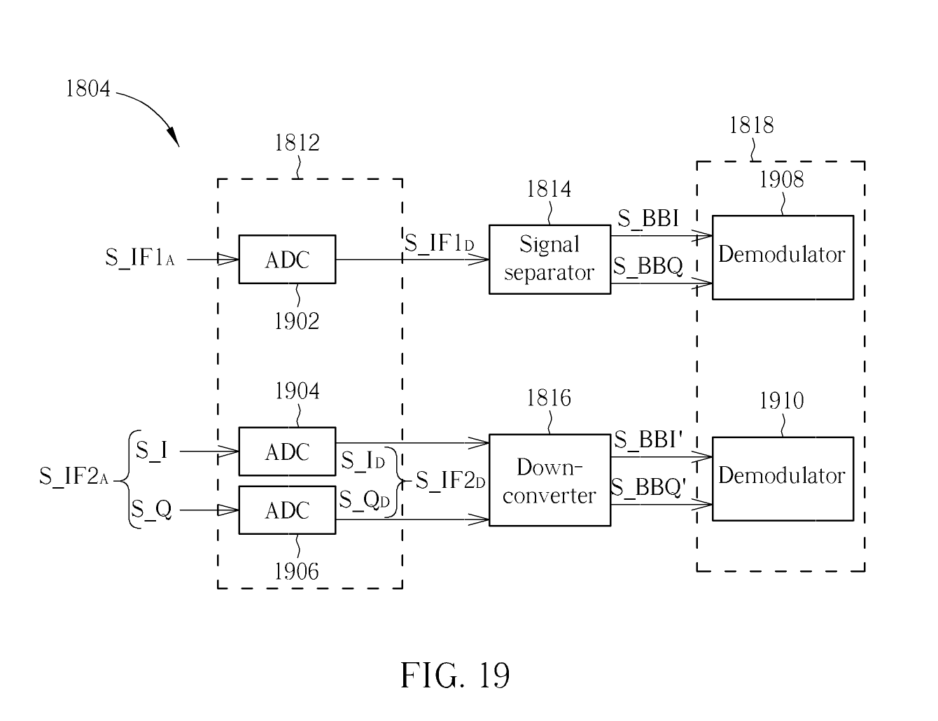

Please refer to FIG. 19, which is a diagram illustrating a first exemplary implementation of the demodulation circuit 1804 shown in FIG. 18. As shown in FIG. 19, the ADC module 1812 includes a plurality of analog-to-digital converters 1902, 1904, and 1906, and the demodulator module 1818 includes a plurality of demodulators 1908 and 1910. The ADC 1902 is coupled to the signal separator 1814, and arranged to convert the analog IF signal (i.e., the analog IF output S_IF1_{A}) into the digital IF output S_IF1_{D}. The ADC 1904 is coupled to the down-converter 1816, and arranged to convert the analog in-phase IF signal S_I into a digital in-phase IF signal S_I_{D} to the down-converter 1816, and the ADC 1906 is coupled to the down-converter 1816, and arranged to convert the analog quadrature-phase IF signal S_Q into a digital quadrature-phase IF signal S_Q′ to the down-converter 1816, wherein the second digital IF output S_IF2_{D} includes the digital in-phase IF signal S_I_{D} and the digital quadrature-phase IF signal S_Q_{D}. Regarding the demodulator module 1818, the demodulators 1908 and 1910 are dedicated to demodulating outputs of the signal separator 1814 and down-converter 1816, respectively. That is, the demodulator 1908 is arranged to demodulate the digital in-phase baseband signal S_BBI and the digital quadrature-phase baseband signal S_BBQ, and the demodulator 1910 is arranged to demodulate the digital in-phase baseband signal S_BBI′ and the digital quadrature-phase baseband signal S_BBQ′.

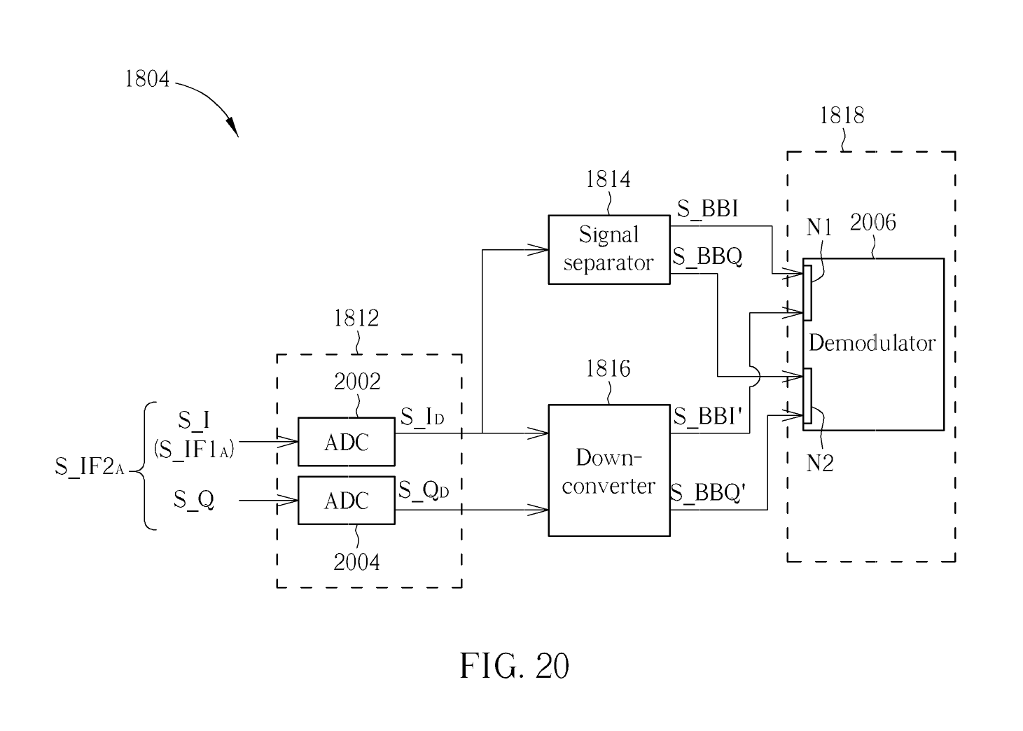

Please note that the aforementioned hardware sharing technique may also be employed in the multi-mode wireless communication receiver 1800. For example, the down-conversion circuit 1802 and/or the demodulation circuit 1804 may employ the hardware sharing technique for reducing the circuitry complexity and power consumption. Please refer to FIG. 20, which is a diagram illustrating a second exemplary implementation of the demodulation circuit 1804 shown in FIG. 18. As shown in FIG. 20, the analog IF output S_IF2_{A} provided by the preceding down-conversion circuit (not shown) includes an analog in-phase IF signal S_I and an analog quadrature-phase IF signal S_Q, and the analog IF output S_IF1_{A} provided by the preceding down-conversion circuit (not shown) includes an analog IF signal being one of the analog in-phase IF signal S_I and the analog quadrature-phase IF signal S_Q (e.g., S_IF1_{A}=S_I). The ADC module 1812 includes a plurality of analog-to-digital converters 2002 and 2004. The ADC 2002 is coupled to the signal separator 1814 and the down-converter 1816, and arranged to convert one of the analog in-phase IF signal S_I and the analog quadrature-phase IF signal S_Q into one digital IF signal. The ADC 2004 is coupled to the down-converter 1816 and arranged to convert the other of the analog in-phase IF signal S_I and the analog quadrature-phase IF signal S_Q into another digital IF signal. In this exemplary embodiment, the ADC 2002 generates a digital IF signal S_I_{D} to both of the signal separator 1814 and the down-converter 1816, and the ADC 2004 generates a digital IF signal S_Q_{D} to the down-converter 1816, wherein the aforementioned digital IF output S_IF1_{D} includes the digital IF signal S_I_{D}, and the aforementioned digital IF output S_IF2_{D} includes the digital IF signals S_I_{D} and S_Q_{D}.

Due to the fact that outputs of the signal separator 1814 and the down-converter 1816 have the same IQ signal format, the demodulator module 1818 may be implemented by a demodulator 2006 shared by the signal separator 1814 and the down-converter 1816. Therefore, the demodulator 2006 has a first input port N1 for receiving the I-branch signal (e.g., S_BBI/S_BBI′) and a second input port N2 for receiving a Q-branch signal (e.g., S_BBQ/S_BBQ′), and demodulate the received I-branch signal and Q-branch signal. The objective of performing demodulation upon either of the single-phase down-conversion output and the dual-phase down-conversion output is achieved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A single-phase down-converter, comprising:
a mixer, arranged to generate a mixer output signal by mixing a radio frequency (RF) signal and a local oscillator (LO) signal; and
an LO signal generator, coupled to the mixer and arranged to generate the LO signal with a frequency shifted from an RF carrier frequency by a specific intermediate frequency, wherein when image interference exists, the specific intermediate frequency makes the image interference translated to guard band(s) of channel(s).

2. The single-phase down-converter of claim 1, wherein the RF signal is a frequency-shift keying (FSK) modulated signal.

3. The single-phase down-converter of claim 2, wherein the FSK modulated signal complies with a Bluetooth-Low Energy (BT-LE) specification.

4. The single-phase down-converter of claim 1, wherein the specific intermediate frequency is higher than zero and lower than a data rate of transmitted data.

5. The single-phase down-converter of claim 1, wherein the specific intermediate frequency is higher than a data rate of transmitted data.

6. A single-phase down-conversion method, comprising:
generating a local oscillator (LO) signal with a frequency shifted from an RF carrier frequency by a specific intermediate frequency; and
generating a mixer output signal by mixing a radio frequency (RF) signal and the LO signal;
wherein when image interference exists, the specific intermediate frequency makes the image interference translated to guard band(s) of channel(s).

7. The single-phase down-conversion method of claim 6, wherein the RF signal is a frequency-shift keying (FSK) modulated signal.

8. The single-phase down-conversion method of claim 7, wherein the FSK modulated signal complies with a Bluetooth-Low Energy (BT-LE) specification.

9. The single-phase down-conversion method of claim 6, wherein the specific intermediate frequency is higher than zero and lower than a data rate of transmitted data.

10. The single-phase down-conversion method of claim 6, wherein the specific intermediate frequency is higher than a data rate of transmitted data.

11. A multi-mode wireless communication receiver, comprising:
a single-phase down-conversion receiving circuit, arranged to perform a single-phase down-conversion upon a radio frequency (RF) signal;
a dual-phase down-conversion receiving circuit, arranged to perform a dual-phase down-conversion upon the RF signal; and
a controller, coupled to the single-phase down-conversion receiving circuit and the dual-phase down-conversion receiving circuit, the controller arranged to detect existence of image interference and control enabling of the single-phase down-conversion receiving circuit and the dual-phase down-conversion receiving circuit according to an image interference detection result.

12. The multi-mode wireless communication receiver of claim 11, wherein the controller is arranged to detect existence of the image interference by referring to information provided from the dual-phase down-conversion receiving circuit.

13. The multi-mode wireless communication receiver of claim 11, wherein the controller makes the single-phase down-conversion receiving circuit enabled and the dual-phase down-conversion receiving circuit disabled when the image interference detection result indicates that there is no image interference, and makes the dual-phase down-conversion receiving circuit enabled and the single-phase down-conversion receiving circuit disabled when the image interference detection result indicates that there is image interference.

14. The multi-mode wireless communication receiver of claim 11, wherein the single-phase down-conversion receiving circuit comprises:
a first down-converter, arranged to generate a first mixer output signal by mixing the RF signal and a first local oscillator (LO) signal;
a first controllable gain amplifier and filter block, coupled to the first down-converter and arranged to generate a first received signal by processing the first mixer output signal; and
a shared demodulator block; and
the dual-phase down-conversion receiving circuit comprises:
the first down-converter;
the first controllable gain amplifier and filter block;
a second down-converter, arranged to generate a second mixer output signal by mixing the RF signal and a second LO signal;
a second controllable gain amplifier and filter block, coupled to the second down-converter and arranged to generate a second received signal by processing the second mixer output signal; and
the shared demodulator block, coupled to the first controllable gain amplifier and filter block and the second controllable gain amplifier and filter block, wherein the demodulator block is arranged to demodulate the first received signal when the controller makes the single-phase down-conversion receiving circuit enabled, and arranged to demodulate the first received signal and the second received signal when the controller makes the dual-phase down-conversion receiving circuit enabled.

15. The multi-mode wireless communication receiver of claim 11, wherein the controller comprises:
a multiplexer, having a first input port, a second input port, and an output port; and
a control unit, arranged to detect existence of the image interference and control the output port to be selectively coupled to the first input port or the second input port according to the image interference detection result;
the single-phase down-conversion receiving circuit comprises:
a first down-converter, arranged to generate a first mixer output signal to the first input port of the multiplexer by mixing the RF signal and a first local oscillator (LO) signal;
a shared controllable gain amplifier and filter block, coupled to the output port of the multiplexer and arranged to generate a received signal according to a multiplexer output signal generated from the output port; and
a shared demodulator block, coupled to the shared controllable gain amplifier and filter block and arranged to demodulate the received signal; and
the dual-phase down-conversion receiving circuit comprises:
the first down-converter;
a second down-converter, arranged to generate a second mixer output signal to the second input port of the multiplexer by mixing the RF signal and a second LO signal;
an image-rejection mixer, coupled to the first down-converter and the second down-converter, the image-rejection mixer arranged to generate a third mixer output signal to the second input port of the multiplexer according to the first mixer output signal and the second mixer output signal;
the shared controllable gain amplifier and filter block; and
the shared demodulator block.

16. The multi-mode wireless communication receiver of claim 11, wherein the controller comprises:
a multiplexer, having a first input port, a second input port, and an output port; and
a control unit, arranged to detect existence of the image interference and control the output port to be selectively coupled to the first input port or the second input port according to the image interference detection result;
the single-phase down-conversion receiving circuit comprises:
a first down-converter, arranged to generate a first mixer output signal by mixing the RF signal and a first local oscillator (LO) signal;
a first filter, coupled to the first down-converter and arranged to generate a first filter output signal to the first input port of the multiplexer according to the first mixer output signal;
a shared controllable gain amplifier block, coupled to the output port of the multiplexer and arranged to generate a received signal according to a multiplexer output signal generated from the output port; and
a shared demodulator block, coupled to the shared controllable gain amplifier block and arranged to demodulate the received signal; and
the dual-phase down-conversion receiving circuit comprises:
the first down-converter;
the first filter;
a second down-converter, arranged to generate a second mixer output signal by mixing the RF signal and a second LO signal;
a second filter, coupled to the second down-converter and arranged to generate a second filter output signal according to the second mixer output signal;
an image-rejection mixer, coupled to the first filter and the second filter, the image-rejection mixer arranged to generate a third mixer output signal to the second input port of the multiplexer according to the first filter output signal and the second filter output signal;
the shared controllable gain amplifier block; and
the shared demodulator block.

17. A multi-mode wireless communication receiver, comprising:
a down-conversion circuit, arranged to perform a single-phase down-conversion upon a radio frequency (RF) signal and accordingly generate a first analog intermediate frequency (IF) output, and arranged to perform a dual-phase down-conversion upon the RF signal and accordingly generate a second analog IF output;
a demodulation circuit, comprising:
an analog-to-digital converter (ADC) module, arranged to convert the first analog IF output into a first digital IF output, and convert the second analog IF output into a second digital IF output;
a signal separator, arranged to separate the first digital IF output into a first digital in-phase baseband signal and a first digital quadrature-phase baseband signal;
a down-converter, arranged to convert the second digital IF output into a second digital in-phase baseband signal and a second digital quadrature-phase baseband signal; and
a demodulator module, arranged to demodulate the first digital in-phase baseband signal and the first digital quadrature-phase baseband signal, and demodulate the second digital in-phase baseband signal and the second digital quadrature-phase baseband signal; and
a controller, coupled to the demodulation circuit and arranged to detect existence of image interference according to the second digital in-phase baseband signal and the second digital quadrature-phase baseband signal, and control the demodulation circuit according to an image interference detection result.

18. The multi-mode wireless communication receiver of claim 17, wherein the second analog IF output includes an analog in-phase IF signal and an analog quadrature-phase IF signal; the first analog IF output includes an analog IF signal; and the ADC module comprises:
a first ADC, coupled to the signal separator and arranged to convert the analog IF signal into the first digital IF output;
a second ADC, coupled to the down-converter and arranged to convert the analog in-phase IF signal into a digital in-phase IF signal to the down-converter; and
a third ADC, coupled to the down-converter and arranged to convert the analog quadrature-phase IF signal into a digital quadrature-phase IF signal to the down-converter, wherein the second digital IF output includes the digital in-phase IF signal and the digital quadrature-phase IF signal.

19. The multi-mode wireless communication receiver of claim 17, wherein the second analog IF output includes an analog in-phase IF signal and an analog quadrature-phase IF signal; the first analog IF output include an analog IF signal being one of the analog in-phase IF signal and the analog quadrature-phase IF signal; and the ADC module comprises:
a first ADC, coupled to the signal separator and the down-converter, the first ADC arranged to convert one of the analog in-phase IF signal and the analog quadrature-phase IF signal into a first digital IF signal to the signal separator and the down-converter; and
a second ADC, coupled to the down-converter and arranged to convert the other of the analog in-phase IF signal and the analog quadrature-phase IF signal into a second digital IF signal to the down-converter, wherein the first digital IF output includes the first digital IF signal, and the second digital IF output includes the first digital IF signal and the second digital IF signal.

20. The multi-mode wireless communication receiver of claim 17, wherein the demodulator module comprises:
a first demodulator, arranged to demodulate the first digital in-phase baseband signal and the first digital quadrature-phase baseband signal; and
a second demodulator, arranged to demodulate the second digital in-phase baseband signal and the second digital quadrature-phase baseband signal.

21. The multi-mode wireless communication receiver of claim 17, wherein the demodulator module comprises:
a demodulator, shared between the signal separator and the down-converter.

22. The multi-mode wireless communication receiver of claim 17, wherein when the image interference detection result indicates that there is no image interference, the controller makes the signal separator enabled and the down-converter disabled; and when the image interference detection result indicates that there is image interference, the controller makes the signal separator disabled and the down-converter enabled.
